(19) United States
(12) Patent Application Publication
(10) Pub. No.: US 2007/0130046 A1
(43) Pub. Date: Jun. 7, 2007

(54) Quality of service for transmission of digital content

(76) Inventors: Shabbir Khan, San Jose, CA (US); Alexander Cohen, Mill Valley, CA (US)

Correspondence Address: BERKELEY LAW & TECHNOLOGY GROUP, LLP, 1700 NW 167TH PLACE, SUITE 240, BEAVERTON, OR, 97006, US

(21) Appl. No.: 11/295,769

(22) Filed: Dec. 6, 2005

(51) Int. Cl. G06Q 40/00

(52) U.S. Cl. 705/37

(57) ABSTRACT

Methods, and/or systems, and/or apparatus for specifying quality of service for transmission of digital content are disclosed.

### FIELD

The subject matter disclosed herein relates to the transmission of digital objects in a data transmission network.

### BACKGROUND

Providers of information exchange networks may provide a range of services to customers, including the downloading and uploading of digital content. Download speeds and throughput are typically greater than that provided for the uploading of digital content. It is becoming increasingly desirable to upload digital content of substantial size. Examples of such digital content may include movies, music, databases, etc. The transmission of such digital content may benefit from increased upload speeds and/or throughput. Customers typically do not have the ability to specify upload speeds and/or throughput for uploads of digital content.

To transmit digital content from a source node to a destination node in an information exchange network, one or more intermediary parties, including perhaps one or more service providers, may forward the digital content over a least a portion of a path coupling the source node to the destination node. Such intermediary parties typically own, lease, control and/or operate equipment such as routers and the like for forwarding digital content according to a network protocol such as the Internet Protocol. The intermediary parties incur substantial costs in the deployment, maintenance and operation of equipment for the purpose of forwarding digital content to a destination node.

### BRIEF DESCRIPTION OF THE DRAWINGS

The claimed subject matter will be understood more fully from the detailed description given below and from the accompanying drawings of embodiments which should not be taken to limit the claimed subject matter to the specific embodiments described, but are for explanation and understanding only.

FIG. 1 is a block diagram of an example embodiment of a data transmission network.

FIG. 2 is a block diagram of an example embodiment of a router that may be owned, leased, controlled and/or operated by an intermediary for transmitting at least a portion of a digital object to a destination node.

FIG. 3 is a flow diagram of an example embodiment of a method for specifying quality of service for an upload of a digital object.

FIG. 4 is a flow diagram of an example embodiment of a method for specifying quality of service for an upload of a digital object.

FIG. 5 is a flow diagram of an example embodiment of a method for specifying quality of service for an upload of a digital object.

FIG. 6 is a flow diagram of an example embodiment of a method for specifying quality of service for an upload of a digital object.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, well-known methods, procedures, components and/or circuits have not been described in detail.

Some portions of the detailed description that follows are presented in terms of algorithms, programs and/or symbolic representations of operations on data bits or binary digital signals within a computer memory, for example. These algorithmic descriptions and/or representations may include techniques used in the data processing arts to convey the arrangement of a computer system and/or other information handling system to operate according to such programs, algorithms, and/or symbolic representations of operations.

An algorithm may be generally considered to be a self-consistent sequence of acts and/or operations leading to a desired result. These include physical manipulations of physical quantities. Usually, though not necessarily, these quantities take the form of electrical and/or magnetic signals capable of being stored, transferred, combined, compared, and/or otherwise manipulated. It has proven convenient at times, principally for reasons of common usage, to refer to these signals as bits, values, elements, symbols, characters, terms, numbers and/or the like. It should be understood, however, that all of these and/or similar terms are to be associated with the appropriate physical quantities and are merely convenient labels applied to these quantities.

Unless specifically stated otherwise, as apparent from the following discussions, it is appreciated that throughout the specification discussion utilizing terms such as processing, computing, calculating, determining, and/or the like, refer to the action and/or processes of a computer and/or computing system, and/or similar electronic computing device, that manipulate or transform data represented as physical, such as electronic, quantities within the registers and/or memories of the computer and/or computing system and/or similar electronic and/or computing device into other data similarly represented as physical quantities within the memories, registers and/or other such information storage, transmission and/or display devices of the computing system and/or other information handling system.

Embodiments claimed may include apparatuses for performing the operations herein. This apparatus may be specially constructed for the desired purposes, or it may comprise a general purpose computing device selectively activated and/or reconfigured by a program stored in the device. Such a program may be stored on a storage medium, such as, but is not limited to, any type of disk including floppy disks, optical disks, CD-ROMs, magnetic-optical disks, read-only memories (ROMs), random access memories (RAMs), electrically programmable read-only memories (EPROMs), electrically erasable and/or programmable read only memories (EEPROMs), flash memory, magnetic and/or optical cards, and/or any other type of media suitable for storing electronic instructions, and/or capable of being coupled to a system bus for a computing device and/or other information handling system.

The processes and/or displays presented herein are not inherently related to any particular computing device and/or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments are not described with reference to any particular programming language. It will be appreciated that a variety of programming languages may be used to implement the teachings described herein.

In the following description and/or claims, the terms coupled and/or connected, along with their derivatives, may be used. In particular embodiments, connected may be used to indicate that two or more elements are in direct physical and/or electrical contact with each other. Coupled may mean that two or more elements are in direct physical and/or electrical contact. However, coupled may also mean that two or more elements may not be in direct contact with each other, but yet may still cooperate and/or interact with each other.

It should be understood that certain embodiments may be used in a variety of applications. Although the claimed subject matter is not limited in this respect, the circuits disclosed herein may be used in many apparatuses such as in the transmitters and/or receivers of a radio system. Radio systems intended to be included within the scope of the claimed subject matter may include, by way of example only, wireless personal area networks (WPAN) such as a network in compliance with the WiMedia Alliance, a wireless local area networks (WLAN) devices and/or wireless wide area network (WWAN) devices including wireless network interface devices and/or network interface cards (NICs), base stations, access points (APs), gateways, bridges, hubs, cellular radiotelephone communication systems, satellite communication systems, two-way radio communication systems, one-way pagers, two-way pagers, personal communication systems (PCS), personal computers (PCs), personal digital assistants (PDAs), and/or the like, although the scope of the claimed subject matter is not limited in this respect.

Types of wireless communication systems intended to be within the scope of the claimed subject matter may include, although are not limited to, Wireless Local Area Network (WLAN), Wireless Wide Area Network (WWAN), Code Division Multiple Access (CDMA) cellular radiotelephone communication systems, Global System for Mobile Communications (GSM) cellular radiotelephone systems, North American Digital Cellular (NADC) cellular radiotelephone systems, Time Division Multiple Access (TDMA) systems, Extended-TDMA (E-TDMA) cellular radiotelephone systems, third generation (3G) systems like Wideband CDMA (WCDMA), CDMA-2000, and/or the like, although the scope of the claimed subject matter is not limited in this respect.

Reference throughout this specification to one embodiment or an embodiment means that a particular feature, structure, or characteristic described in connection with the embodiment is included in at least one embodiment. Thus, the appearances of the phrase in one embodiment or an embodiment in various places throughout this specification are not necessarily all referring to the same embodiment. Furthermore, the particular features, structures, or characteristics may be combined in one or more embodiments.

A “data transmission network” as referred to herein relates to infrastructure that is capable of transmitting information among nodes which are coupled to the data transmission network. For example, a data transmission network may comprise links capable of transmitting data between nodes according to one or more data transmission protocols. Such links may comprise one or more types of transmission media capable of transmitting digital objects from a source to a destination. However, these are merely examples of a data transmission network.

In the transmission of digital objects in a data transmission network, a source node may initiate transmission of data to one or more destination nodes coupled to the data transmission network. In one embodiment, although the claimed subject matter is not limited in this respect, a source node may initiate the transmission of data to the destination node based, at least in part, upon a destination address associated with the destination node. According to a communication protocol of a particular embodiment, the source node may transmit data to the destination node in one or more data packets which are routed to the destination node through the data transmission network based, at least in part, on the destination address. However, these are merely examples of how data may be transmitted from a source node to a destination node in a data transmission network, and the scope of the claimed subject matter is not limited in these respects.

A node in a data transmission network may “forward” information to one or more other nodes in the data transmission network over data links. In one particular example, a first node may forward information to a second node by transmitting one or more data packets according to a communication protocol. Such data packets may comprise a header portion containing an address of an intended destination node and a payload containing forwarded information. If the second node is not the ultimate intended destination, the second node may also forward the data packets to a third node which comprises and/or is coupled to the ultimate intended destination node. However, these are merely examples of how information may be forwarded in a data transmission network, and the scope of the claimed subject matter is not limited in this respect.

A “digital object” as referred to herein relates to information that is organized and/or formatted in a digitized form. For example, a digital object may comprise one or more documents, visual media and/or audio media, and/or combinations thereof. However, these are merely examples of the types of information that may be maintained in a digital object, and the scope of the claimed subject matter is not limited in this respect. Such a digital object may be maintained in a compressed format to enable efficient storage of the digital object in a storage medium and/or transmission of the digital object in a data transmission network. In other embodiments, such a digital object may be encrypted for transmission in a secure communication channel. In one embodiment, a digital object may be formatted at a source node or at one or more intermediary nodes for transmission to one or more destination nodes. Also, a digital object may be transmitted to one or more destination nodes as one or more data packets routed to the one or more data nodes according to a communication protocol.

A “bid” as referred to herein relates to an expression of a proposal to perform a service. In one example, a customer and/or client may receive bids from more than one party competing for the business of the customer and/or client. A bid may specify terms under which a service may be formed such as, for example, price, quality, timeliness and/or reliability. However, these are merely examples of terms that may be expressed in a bid and claimed subject matter is not limited in this respect. Also, in some commercial contexts, acceptance of a bid by a customer and/or client may be binding on the parties. In other commercial contexts, however, acceptance of a bid by a customer and/or client, in and of itself, may not be binding. Here, additional actions by one or more parties may result in a binding arrangement. It should be understood that these are merely examples of a bid and claimed subject matter is not limited in this respect.

A “bid request” as referred to herein relates to an expression of an invitation to provide a bid for performing a service. In one particular example, such a bid request may specify a desired service to be performed by a service provider. In some embodiments, the bid request may specify some of the terms, but not necessarily all of the terms, under which a desired service is to be performed. However, these are merely examples of a bid request and claimed subject matter is not limited in these respects.

In response to receipt of a bid from a service provider for providing a service, a potential customer and/or client may provide an “acceptance message” to the bidding service provider. Such an acceptance message may express a willingness of the customer and/or client to receive services from the service provider according to at least some terms set forth in the received bid. However, this is merely an example of an acceptance message and the claimed subject matter is not limited in this respect.

In forwarding a digital object from a source node to a destination node over a data transmission network, equipment which is owned, leased, controlled and/or operated by one or more “intermediaries” or “intermediary parties” may forward at least a portion of the digital object over at least a portion of the data transmission network toward the destination node. As illustrated below, the term “intermediary” may refer to a party that may forward a digital object over at least a portion of the data transmission network and/or equipment that is owned, leased, controlled and/or operated by the party for performing this service.

Equipment that is owned, leased, controlled and/or maintained by an intermediary may comprise equipment that is capable of transmitting information to and/or receiving information from a data transmission network. Here, such equipment may comprise one or more “communication ports” capable of receiving information from a source node and/or transmitting information to a destination node over one or more data transmission mediums forming links in the data transmission network. Such a communication port may be capable of transmitting and/or receiving information from any one of several types of data transmission media such as, for example, cabling (e.g., optical, coaxial, unshielded twisted wire pair cabling, etc.) and/or wireless transmission media (e.g., by terrestrial or satellite links). However, these are merely examples of a communication port that may couple equipment which is owned, leased controlled and/or operated by an intermediary to a data transmission network, and claimed subject matter is not limited in these respects.

“Instructions” as referred to herein relate to expressions which represent one or more logical operations. For example, instructions may be “machine-readable” by being interpretable by a machine for executing one or more operations on one or more data objects. However, this is merely an example of instructions and claimed subject matter is not limited in this respect. In another example, instructions as referred to herein may relate to encoded commands which are executable by a processing circuit having a command set which includes the encoded commands. Such an instruction may be encoded in the form of a machine language understood by the processing circuit. Again, these are merely examples of an instruction and claimed subject matter is not limited in this respect.

“Storage medium” as referred to herein relates to media capable of maintaining expressions which are perceivable by one or more machines. For example, a storage medium may comprise one or more storage devices for storing machine-readable instructions and/or information. Such storage devices may comprise any one of several media types including, for example, magnetic, optical or semiconductor storage media. However, these are merely examples of a storage medium and claimed subject matter is not limited in these respects.

“Logic” as referred to herein relates to structure for performing one or more logical operations. For example, logic may comprise circuitry which provides one or more output signals based upon one or more input signals. Such circuitry may comprise a finite state machine which receives a digital input and provides a digital output, or circuitry which provides one or more analog output signals in response to one or more analog input signals. Such circuitry may be provided in an application specific integrated circuit (ASIC) or field programmable gate array (FPGA). Also, logic may comprise machine-readable instructions stored in a storage medium in combination with processing circuitry to execute such machine-readable instructions. However, these are merely examples of structures which may provide logic and claimed subject matter is not limited in this respect.

An “agent” as referred to herein relates to a process that executes on a first device and is capable of communicating with a second device over a data transmission network. In one particular embodiment, for example, an agent process may collect information associated with the first device and enable transmission of the collected information to the second device. In another embodiment, an agent may receive control signals from the second device to enable remote control of at least one aspect of the first device. However, these are merely examples of how an agent may enable communication between devices and the claimed subject matter is not limited in these respects. In another embodiment, an agent may execute on a processor under the control of machine-readable instructions stored on a storage medium. In another embodiment, an agent may be executed on different types of structure that provide logic. However, these are merely examples of an agent and claimed subject matter is not limited in these respects.

A “quality of service” (“QoS”) as referred to herein relates to a characteristic of a data transmission service to provide data to a recipient within time constraints. A quality of service may refer to a characteristic of a transmission control protocol/intemet protocol (TCP/IP) type protocol, and/or a user datagram protocol/internet protocol (UDP/IP) type protocol. In one or more embodiments, a quality of service may refer to a threshold error transmission rate, for example where one or more data packets may not arrive, and/or where one or more data packets that do arrive may include one or more corrupted bits of information. In one or more embodiments, a quality of service may refer to where no errors and/or the error rate may not exceed a predetermined value, and/or to a range within which a number of errors and/or an error rate may be acceptable, although the scope of the claimed subject matter is not limited in this respect. In a particular embodiment, for example, a QoS may be associated with the transmission of a digital object from a source node to a destination node. Here, for example, a QoS may specify that all or a portion of the digital object arrive at the destination node within some time constraint. In another embodiment, a QoS may define, at least in part, an effective data rate at which a digital object is to be transmitted to the destination node. However, this is merely an example of how QoS may be applied in the transmission of a digital object, and the scope of the claimed subject matter is not limited in this respect.

Unless specifically stated otherwise, as apparent from the following discussion, it is appreciated that throughout this specification discussions utilizing terms such as “processing,” “computing,” “calculating,” “selecting,” “forming,” “enabling,” “inhibiting,” “identifying,” “initiating,” “receiving,” “transmitting,” “determining” and/or the like refer to the actions and/or processes that may be performed by a computing platform, such as a computer or a similar electronic computing device, that manipulates and/or transforms data represented as physical electronic and/or magnetic quantities and/or other physical quantities within the computing platform's processors, memories, registers, and/or other information storage, transmission, reception and/or display devices. Further, unless specifically stated otherwise, process described herein, with reference to flow diagrams or otherwise, may also be executed and/or controlled, in whole or in part, by such a computing platform.

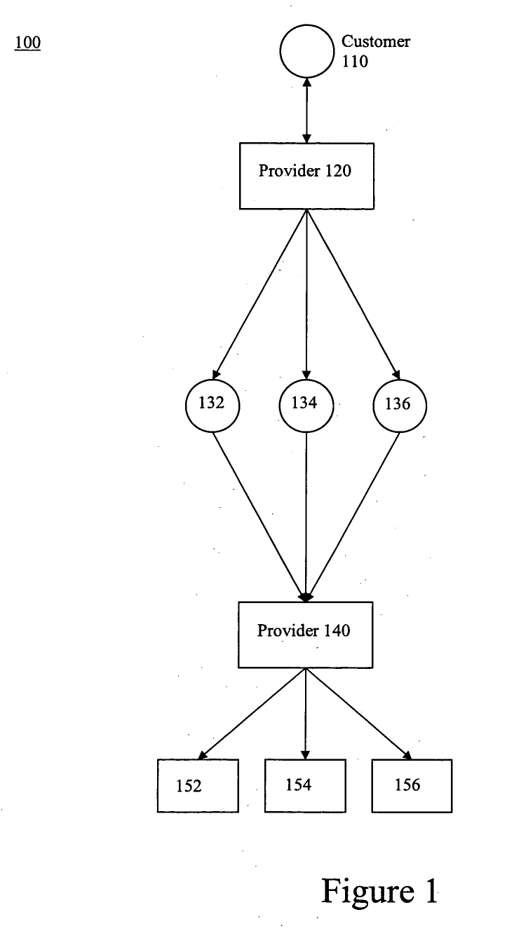

FIG. 1 is a block diagram of an example data transmission network 100. A source node 110 and destination nodes 152, 154, and 156 may access the data transmission network 100 using any one of several data transmission access technologies such as, for example, public switched telephone network (PSTN), digital subscriber line (DSL), coaxial cable or wireless access (e.g., using satellite and/or terrestrial links). However, these are merely examples of how a node may obtain access to a data transmission network and claimed subject matter is not limited in these respects. Data transmission network 100 may be capable of transmitting data packets among nodes in a network topology according to an Internet Protocol (IP). However, this is merely an example of a communication protocol that may be used in the transmission of all or portions of a digital object from a source node to a destination node and the claimed subject matter is not limited in this respect. Here, in the example embodiment illustrated in FIG. 1, source node 110 and destination nodes 152, 154, and 156 may access the data network 100 through the facilities of providers 120 and 140. Providers 120 and 140 may provide access to the Internet and may be referred to as Internet Service Providers (ISP). For example, source node 110 and/or destination nodes 152, 154, and 156 may comprise customers, clients, or subscribers (the terms may be synonymous as used herein) of corresponding ISPs that enable access to the data transmission network 100 for a subscription fee. However, an ISP is merely example of how a source and/or destination node may access a data transmission network and claimed subject matter is not limited in this respect. In another embodiment, both the source node and destination node may be connected to a single ISP serving a dual role of Provider 120 and 140.

According to an embodiment, source node 110 and/or destination nodes 152, 154, and 156 may comprise any one of several types of devices which are capable of transmitting and/or receiving digital objects. In one example, source node 110 and/or destination nodes 152, 154, and 156 may comprise a communication port (not shown) that is adapted for transmitting data to and/or receiving data from an ISP through a data transmission medium using one or more of the aforementioned access technologies. In addition to communication ports, source node 110 and/or destination nodes 152, 154, and 156 may also comprise a computer system employing a processor, one or more memory devices and appropriate input/output devices for communicating between processes executing on the processor and communication ports. Here, such processes executing on a computer system may be controlled, at least in part, by machine-readable instructions stored in one or more memory devices of the computer system. In one particular embodiment, a computer system at source node 110 may execute one or more processes to create and/or format a digital object for transmission on the data transmission network 100. However, this is merely an example of how a source node 110 may create and/or format a digital object for transmission on a data transmission network and claimed subject matter is not limited in this respect. In another embodiment, a computer system at a destination node may execute one or more processes to utilize a digital object received from the data transmission network 100 through a communication port. In another embodiment, either or both of the source and destination nodes may use an agent or a proxy to perform processing in full or in part on behalf of the respective node.

According to an embodiment, equipment that is owned, leased, controlled and/or operated by intermediaries 132, 134, and/or 136 may transmit digital objects between providers 120 and 140. Links coupling the intermediary equipment to providers 120 and 140 may comprise any one of several data transmission mediums such as, for example, cabling (e.g., fiber optic, coaxial and/or unshielded twisted wire pair cabling) and/or wireless transmission media (e.g., using terrestrial and/or satellite based links). However, these are merely examples of transmission media that may be used to transmit digital objects in a data transmission network and claimed subject matter is not limited in these respects.

As illustrated in FIG. 1, provider 120 may transmit a digital object to provider 140 in any one of multiple paths comprising at least one of corresponding intermediaries 132, 134, and 136. Here, according to an embodiment, provider 120 may transmit a digital object to provider 140 through any one of the intermediaries 132,134, and 136. As discussed below, according to an embodiment, provider 120 may select one or more of intermediaries 132, 134, and 136 to forward the digital object to provider 140 based, at least in part, upon one or more bid requests received from customer 110. The paths through intermediaries 132,134, and 136 may differ from one another in terms of transmission speed, quality of service capabilities, etc.

A bid request from customer 110 may include information regarding requested quality of service and/or size of the digital object to be transmitted by customer 110 to a destination node. The bid request may also include information, including, but not limited to, compression of the digital object, encryption of the digital object, proposed price to be paid to provider 120 for facilitating the transmission of the digital object, billing account information, destination address, etc.

According to an embodiment, although claimed subject matter in not limited in this respect, intermediaries 132, 134, and 136 may route digital objects between providers 120 and 140 in one or more data packets formatted according to a particular network protocol such as the Internet Protocol (IP). Such data packets may be forwarded on data links connecting intermediaries 132, 134, and 136 and providers 120 and 140 according to any one of several data link layer protocols such as, for example, Ethernet, Asynchronous Transfer Mode (ATM), Frame Relay and/or Synchronous Optical NETwork/Sychronous Digital Hierarchy (SONET/SDH) data link protocols. In embodiments employing wireless communication links, data packets may be forwarded on such wireless communication links according to any one of several wireless data link protocols such as, for example, IEEE Stds. 802.11 and 802.16. However, these are merely examples of data link protocols that may be used to forward data packets in a data transmission network and claimed subject matter is not limited in this respect. According to an embodiment, providers 120 and 140 and intermediaries 132, 134, and 136 may each comprise one or more routers for forwarding data packets originating at customer 110 to destination nodes.

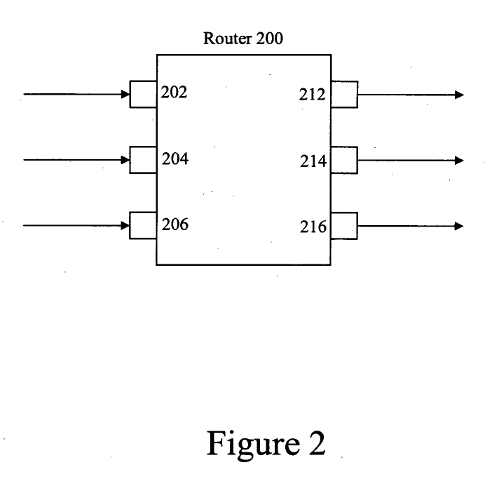

FIG. 2 is a block diagram of a router 200 which may be owned, leased and/or operated at a provider and/or at an intermediary for transmitting at least a portion of a digital object to a destination node according to an embodiment. Router 200 may comprise one or more input ports 202, 204, and 206 to receive data packet communications according to one or more of the aforementioned protocols. Here, one or more of input ports 202, 204, and 206 may be capable of receiving all or a portion of a digital object originating at source node 110. Router 200 may also comprise one or more output ports 212, 214, and 216 to transmit data packet communications according to one or more of the aforementioned protocols. Here, one or more of output ports 212, 214, and 216 may be capable of transmitting all or a portion of a digital object to provider 140 (to then be forwarded to one or more destination nodes).

According to an embodiment, router 200 may comprise logic to determine how to forward packets received on input ports 202, 204, and 206 to output ports 212, 214, and 216. For example, router 200 may determine one of output ports 212, 214, 216 for forwarding a received data packet based, at least in part, on information associated with the received data packet such as, for example, a destination address and possibly based at least in part on bid or bid request information. Here, according to an embodiment, router 200 may determine an output port 212, 214, or 216 for forwarding the received data packet according to one or more look up tables associating destination IP address with output ports 212, 214, and 216. However, this is merely an example of how a router may determine an output port for forwarding a data packet and claimed subject matter is not limited in this respect. Notwithstanding the existence of a valid destination address associated with a received data packet, according to an embodiment, router 200 may also select whether or not to forward a received data packet based, at least in part, on information such as the destination and/or source associated with the data packet, or other information associated with the data packet.

According to an embodiment, the aforementioned logic of router 200 to control routing data packets from an input port to an output port may comprise one or more computer systems comprising one or more processors and memory devices. The memory devices may comprise machine-readable instructions to execute on the one or more processors for controlling the routing of data packets. Alternatively, router 200 may comprise one or more ASIC devices to control routing, and/or combinations of one or more ASIC devices and one or more computer systems to control routing. However, these are merely examples of logic that may be employed in a router for controlling the forwarding of data packets and claimed subject matter is not limited in these respects. In one of more embodiment, router 200 may comprise and/or be implemented by one or more computing platforms as described herein, for example as a network interface card and/or a server adapted to operate at least in part as a router and/or to provide one or more routing functions, although the scope of the claimed subject matter is not limited in this respect.

According to an embodiment, one or more of providers 120 and 140 and/or intermediaries 132, 134, and 136 (FIG. 1) may employ more than one router 200 to forward a digital object to a destination node. A digital object received from customer 110 at a first router may be forwarded to a second router where both first and second routers are owned, leased, controlled and/or operated by provider 120 or one of intermediaries 132, 134, and 136. Here, the first router may receive the digital object from the customer 110 and forward the received digital object to the second router either directly to the second router or via one or more other routing devices. The second router may then forward to provider 140 the digital object received from the first router. However, this is merely an example of how one or more intermediaries may employ multiple routers for forwarding a digital object from a source node to a destination node, and claimed subject matter is not limited in this respect.

According to an embodiment, one or more of nodes 132-136 and/or ISP 120 and/or ISP 140 may employ Multiprotocol Label Switching (MPLS) according to the MPLS Architecture set forth, for example, in Internet Engineering Task Force (IETF), Network Working Group, RFC 3031, 2001. In such an embodiment, ISP 120 may comprise a label edge router (LER) that is capable of assigning label values to packets received from source node 110 for transmission to one or more of destination nodes 152-156. One or more routers 200 of nodes 132-136 may comprise a Label Switch Router (LSR) to make forwarding decisions for received data packets based, at least in part, upon label values assigned to the received data packets. At a network hop between ISP 120 and ISP 140, an LSR associated with one or more of nodes 132-136 may remove an existing label of a received data packet and apply a new label indicating how the next, downstream LSR is to forward the data packet to a destination. Label switch routers coupled to forward a digital object from ISP 120 to ISP 140 may then form a Label Switch Path (LSP) determined, at least in part, according to labels, selected from a hierarchy of labels known as a label stack, assigned to data packets transporting the digital object at network hops between ISP 120 and ISP 140. However, this is merely an example of how a digital object may be transmitted between nodes on a data transmission network using MPLS, and the scope of the claimed subject matter is not limited in this respect.

In one or more embodiments, router 200 may implement routing of packets and/or data using existing processes, routing tables, and/or MPLS to shape the flow of traffic, optionally without consideration for the object-based QoS requirements and/or other criteria as it pertains to the transmission of a particular digital object and/or a series of objects. In one or more embodiments, router 200 may implement routing of packets and/or data using existing processes, routing tables, and/or MPLS to shape the flow of traffic, optionally including consideration for the object-based QoS requirements and/or other criteria as it pertains to the transmission of a particular digital object and/or a series of objects. In one or more embodiments, router 200 may be programmed with software and/or firmware to implement routing of packets and/or data, and in one or more alternative embodiments, router 200 may be wired and/or utilize switches to implement routing of packets and/or data at a predetermined QoS based at least in part on packet traffic, although the scope of claimed subject matter is not limited in this respect. In one or more embodiments, instructions by which router 200 may be arranged to route and/or forward packets may be received from a source external to router 200, and in one or more embodiments, router 200 may be arranged to forward predetermined packets and/or digital objects in a predetermined setting, for example where one of input ports 202-206 may be coupled to one or more output ports 212-216, which may be arranged, for example, to last for a predetermined period of time, although the scope of claimed subject matter is not limited in this respect.

In one or more embodiments, network 100 as shown in FIG. 1 may determine a route for transmitting a digital object between a router 200 at ISP 120 and a router at ISP 140, a route for transmitting a digital object between a router 200 at one of intermediary nodes 132-136 and a router 200 at another of intermediary nodes 132-136, and/or a route for transmitting a digital object between a router at an intermediary node 132-136 and ISP 120 and/or ISP 140. When source node 110 is prepared to send a digital object to one or more of destination nodes 152-156, source node 110 may transmit the digital object to ISP 120 where the digital object may include information relating to the digital object to be sent. Such information relating to the digital object to be sent may be referred to as digital object information. Such digital object information may include, for example, the size of the digital object, for example in megabytes, the priority of the digital object with respect to a priority of one or more other digital objects, the time frame in which it may be desired to transmit the digital object, the link quality that may be desired between source node 110 and one or more of destination nodes 152-156, a quality of service (QoS) that-may be desired between source node 110 and one or more of destination nodes 152-156, a latency parameter that may be desired between source node 110 and one or more of destination nodes 152-156, the type of information that the digital object comprises, for example text data, e-mail data, HTML data, media data, the format of the data file, and so on. In one or more embodiments, digital object information may comprise a digital transmission form (DTF). Such a digital transmission form (DTF), for example, may comprise predefined fields that specify terms of a service request for the service of transmitting a digital object to a destination node. Such predefined fields may be used for providing information to a requesting party such as, for example, size of the digital object to be transmitted, for example in bits, bytes, cells, packets, and/or the like, destination address and/or addresses, QoS, compression format, security/encryption, billing account number, and so on. However, these are merely examples of predefined fields that may be used in a DTF for providing a service request, and the scope of claimed subject matter is not limited in these respects. In one or more embodiments, digital object information may be incorporated, wholly or at least in part, with the digital object. For example, digital object information may comprise a header and/or be contained within a header of the digital object. In one or more alternative embodiments, digital object information may be an object that is separate, wholly or at least in part, from the digital object itself. For example, digital object information may be a separate routing bill and/or stub that contains destination information pertaining to the digital object, sender information, receiving information, quality of service information, routing path information, and so on. In such embodiments, the digital object information may be routed along with the digital object, or alternatively may be routed independently from the digital object, at least in part, and/or may follow a different transmission path along network 100. In one or more embodiments, digital object information may indicate to one or more downstream nodes, such as nodes 114, what is coming and/or contained in the digital object, and/or the requested quality of service, and/or a request for information from the downstream nodes whether the downstream nodes can handle the digital object, store the digital object, forward the digital object, and so on. In one or more embodiments, the digital object information may reach the same destination as the digital object, and in one or more alternative embodiments the digital object information may not actually reach and/or may not be required to reach the same destination as the digital object. However, these are merely examples of how digital object information may be embodied, and the scope of the claimed subject matter is not limited in these respects.

In one or more embodiments, a digital object (DO) may refer to the payload to be transmitted on network 100, for example a movie file, and a digital transmission file (DTF) may refer to information regarding the digital object, which may be referred to as digital object information. For example, a digital transmission form may be another object, typically smaller, but not necessarily smaller, than the digital object, and may be an object independent from the digital object itself, that represents the digital object and/or information regarding the digital object. In one embodiment, the digital transmission form may comprise metadata about the digital object, for example size, bid, charges, QoS, routing information, and/or the like. The digital transmission form may traverse the same path in network 100 as the digital object, and/or the digital transmission form may traverse a path that is different at least in part from the digital object. In one or more embodiments, a digital transmission form may not be required and/or utilized, for example where preexisting agreements and/or prearranged routs may exist to handle the forwarding of the digital object. In other embodiments, a digital transmission form may be utilized as an instrument in which bids and/or costs for forwarding the digital object on network 100 may be utilized and/or negotiated priorto the transmission of the digital object on network 100. In any given network in certain embodiments, a digital object may include a corresponding digital transmission form, and in other embodiments, a digital object may not have a corresponding digital transmission form. However, these are merely examples of how a digital transmission form may be utilized to transmit a digital object via network 100, and the scope of claimed subject matter is not limited in these respects.

In one or more embodiments, a digital object may be sufficiently large such that it may be desirable to split the digital object into one or more sub-objects, for example at source node 110 and/or at one or more of intermediary nodes 132-136, where one or more of the sub-objects may be provided with its own individual routing requirements, quality of service, routing paths, and so on, and where the sub-objects may be reassembled at one or more of intermediary nodes 132-136 and/or one or more of destination nodes 152-156. Such a sub-object concept in one or more embodiments may be analogous to data transfer utilizing packets, where the sub-objects may be at a higher level of organization than that of packets, but may be at a lower level of organization than the digital object itself. For example, a multimedia object may be split into a video sub-object and an audio sub-object, and/or a multimedia object may be split into a sub-objects corresponding to the scenes contained in the multimedia object, although the scope of claimed subject matter is not limited in this respect. An example of such a digital object that may be suitable for being split up into one or more smaller objects may be where the digital object is a movie. In one or more embodiments, a transmission of such an object may include a multiple input, multiple output (MIMO) transmission system and/or a spatial division, multiple access system, for example where two or more sub-objects may be transmitted in parallel in two or more links. In one particular embodiment, a network that may be suitable for splitting a digital object into one or more sub-objects may comprise at least a portion of the network operating in compliance with an Institute of Electrical and Electronics Engineers (IEEE) 802.16 type standard such as a WiMax type standard, although the scope of claimed subject matter is not limited in this respect.

According to some embodiments data transmission networks, for example embodiments of data transmission network 100 shown in FIG. 1, an ISP and/or an intermediary may incur a cost for forwarding a digital object through at least a portion of a data transmission network. To offset such a cost, an ISP and/or an intermediary may receive compensation from a party associated with a source node, provider and/or destination node in exchange for forwarding a digital object over a portion of the network. According to an embodiment, an intermediary may provide a bid specifying terms under which the intermediary would forward a digital object over at least a portion of a data transmission network. A party that is to compensate an intermediary may select from among multiple bids for the business of forwarding the digital object over at least a portion of the network. A provider may select from. among various bids from various intermediaries according at least in part to requested quality of service and data object size specified by customer 110 in a bid request or in an acceptance message. However, this is merely an example embodiment and claimed subject matter is not limited in these respects.

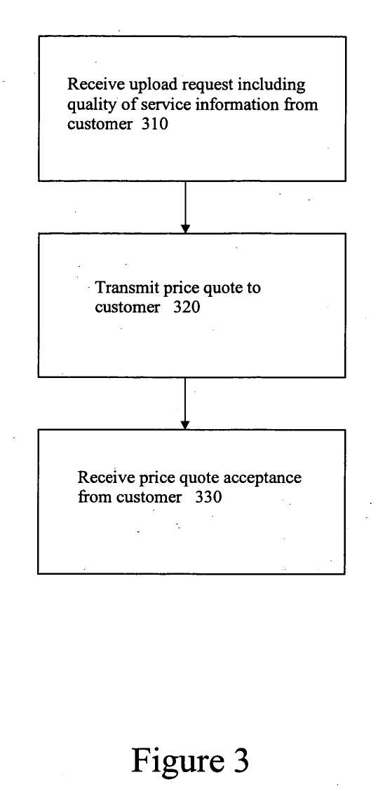

FIG. 3 is a flow diagram of an example embodiment of a method for specifying quality of service for an upload of a digital object. The example embodiment of FIG. 3 may include all, more than all, and/or less than all of blocks 310-330, and furthermore the order of blocks 310-330 is merely an example order, and the scope of the claimed subject matter is not limited in this respect. At block 310, an upload request is received from a customer. The upload request may be received at a provider such as an ISP. The upload request may comprise a bid request as described above, and may include information regarding requested quality of service level. The upload request may also include information regarding other aspects of a digital object to be uploaded, including, but not limited to, size of the digital object, compression of the digital object, encryption or other security measures, billing account information, delivery time, permissible error rates, etc.

At block 320, a price quote is transmitted to the customer by the provider. The price quote may comprise a bid as described above. The price quote may be based at least in part on the upload request information previously received from the customer. If the price quote is accepted by the customer, a price quote acceptance is received from the customer at block 330.

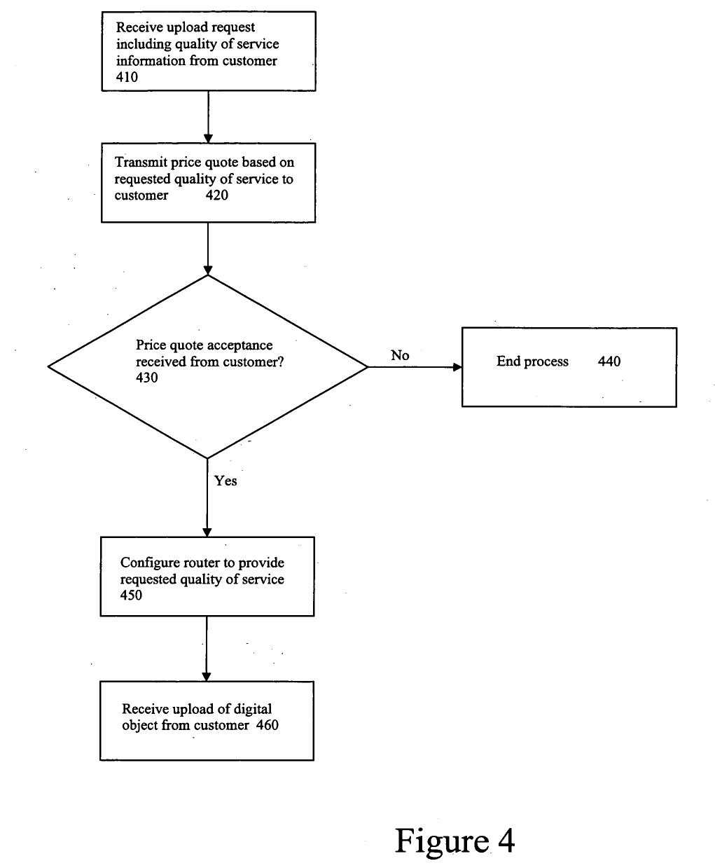

FIG. 4 is a flow diagram of an example embodiment of a method for specifying quality of service for an upload of a digital object. The example embodiment of FIG. 4 may include all, more than all, and/or less than all of blocks 410-460, and furthermore the order of blocks 410-460 is merely an example order, and the scope of the claimed subject matter is not limited in this respect. At block 410, an upload request is received from a customer. The upload request may be received at a provider such as an ISP. The upload request may comprise a bid request as described above, and may include information regarding requested quality of service level. The upload request may also include information regarding other aspects of a digital object to be uploaded, including, but not limited to, size of the digital object, compression of the digital object, encryption or other security measures, billing account information, delivery time, etc.

At block 420, a price quote is transmitted to the customer by the provider. The price quote may comprise a bid as described above. The price quote may be based at least in part on the upload request information previously received from the customer, including requested quality of service.

If a price quote acceptance message is not received from the customer at block 430 or an acceptance has not been pre-arranged, the process ends at block 440. If terms including a price quote are accepted at block 430, a router is configured at block 450 to provide the requested quality of service. An upload of a digital object is received from the customer at block 460.

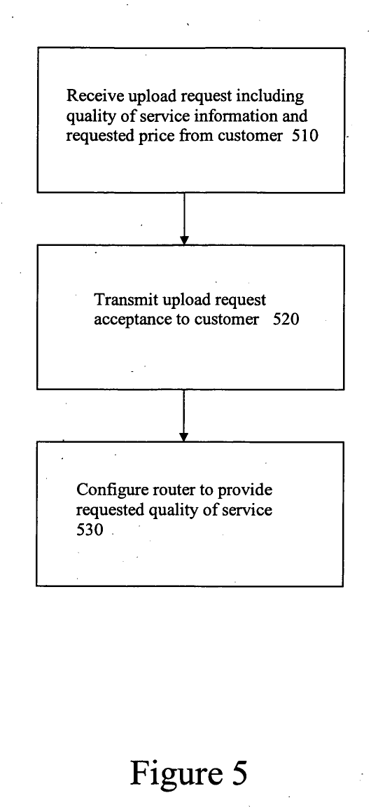

FIG. 5 is a flow diagram of an example embodiment of a method for specifying quality of service for an upload of a digital object. The example embodiment of FIG. 5 may include all, more than all, and/or less than all of blocks 510-530, and furthermore the order of blocks 510-530 is merely an example order, and the scope of the claimed subject matter is not limited in this respect. At block 510, an upload request is received from a customer. The upload request for this example may include information regarding requested quality of service and proposed price information. The upload request may also include information regarding other aspects of a digital object to be uploaded, including, but not limited to, size of the digital object, compression of the digital object, encryption or other security measures, billing account information, delivery time, etc. At block 520, an upload request acceptance message is delivered to the costumer, and at block 530 a router is configured to provide the requested quality of service.

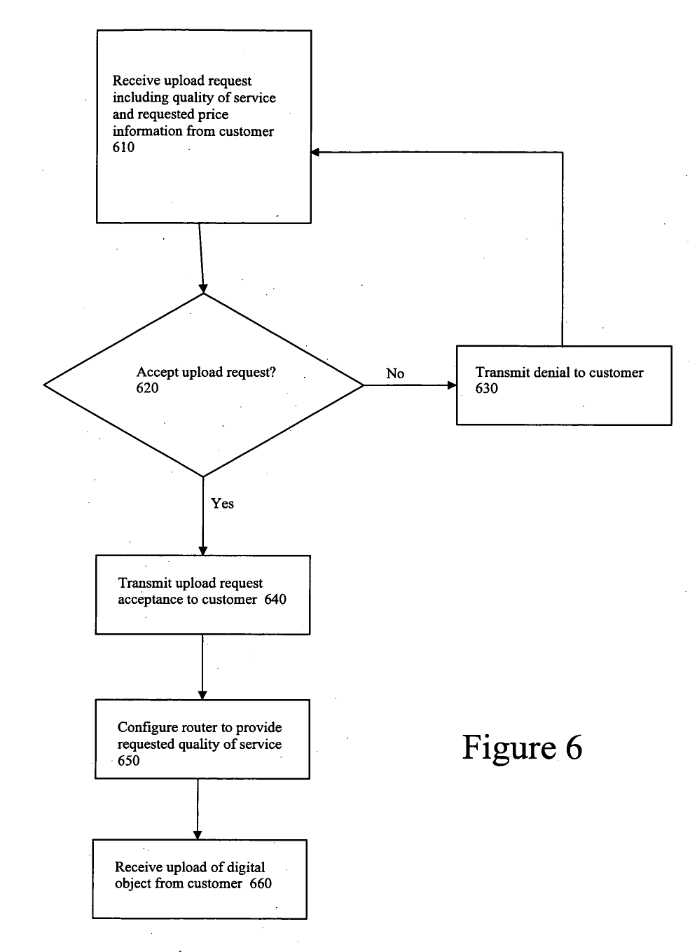

FIG. 6 is a flow diagram of an example embodiment of a method for specifying quality of service for an upload of a digital object. The example embodiment of FIG. 6 may include all, more than all, and/or less than all of blocks 610-630, and furthermore the order of blocks 610-630 is merely an example order, and the scope of the claimed subject matter is not limited in this respect. At block 610, an upload request is received from a customer. The upload request for this example may include information regarding requested quality of service and proposed price information. The upload request may also include information regarding other aspects of a digital object to be uploaded, including, but not limited to, size of the digital object, compression of the digital object, encryption or other security measures, billing account information, delivery time, etc. The upload request may be received by a provider such as an ISP.

At block 620, a determination is made as to whether the upload request is accepted. For this example, the provider may make the determination based at least in part on the information included in the upload request. If the upload request is not accepted, a denial message is transmitted to the customer at block 630. For an embodiment, the customer may elect to send a new upload request.

If the upload request is accepted, an upload request acceptance message is transmitted to the customer at block 640. At block 650, a router is configured to provide the requested quality of service, and at block 660 an upload of a digital object is received from the customer. The digital object may be transmitted by the provider to a destination node according to the terms of the accepted upload request. In one embodiment, either the source or the ISP may not perform one or more functions described in connection with FIGS. 3-6 due to pre-existing arrangements and/or agreements between the parties.

All or some portions of the example embodiments of methods discussed herein may be performed by logic at a provider such as an ISP. In one embodiment, portions of embodiments may be formed at a proxy server (e.g., at an ISP or other unidentified node in a data transmission network) that is capable of communicating with the source node (customer) and one or more intermediaries. A source node may form a digital object for transmission to one or more destination nodes. In an embodiment, a computer operator may form the digital object through interactions with a graphical user interface (GUI) of a computing platform associated with and/or coupled to the source node. However, this is merely an example of how a digital object may be formed and claimed subject matter is not limited in these respects. In an embodiment, the digital object may be formatted into one or more data packets according to a network protocol such as the IP protocol. As such, the one or more data packets may comprise a header portion comprise a destination IP address associated with a destination node.

A particular intermediary in a data transmission network such as network 100 may or may not be capable of transmitting the digital object to a destination node while adhering to requested levels of quality of service. For an example embodiment, a provider may identify intermediaries that are capable of forwarding the digital object to one or more destination nodes while adhering to requested levels of quality of service. In one embodiment, a provider may identify intermediaries that are capable of forwarding a digital object based, at least in part, on information in a database. Such a database may be maintained at the provider and/or proxy server and may identify particular intermediaries that are connected to the source node and capable of receiving digital objects for forwarding. Such a database may also associate information with intermediaries such as, for example, capability to forward digital objects while achieving a certain QoS, operational status (e.g., functioning, down for maintenance, malfunctioning, etc.) and information indicative of destinations to which the intermediaries may forward digital objects. However, this is merely an example of information that may be associated with intermediaries in a database for the purpose of identifying intermediaries which are capable of forwarding digital object to a destination and claimed subject matter is not limited in this respect.

In addition to a customer negotiating with a provider for the provider to facilitate an upload adhering to requested parameters for a price, embodiments are possible where the provider may request bids from intermediaries for the service of forwarding the digital object to one or more destination nodes. A provider and/or proxy server may transmit bid requests to intermediaries according to any one of several communication protocols. In one embodiment, for example, a provider and/or proxy server may transmit bid requests in one or more data packets using a user datagram protocol/Internet protocol (UDP/IP). However, these are merely examples of how a provider and/or proxy server may transmit a bid request to one or more intermediaries and claimed subject matter is not limited in these respects.

According to an embodiment, bids and bid requests may be formatted into digital transmission forms (DTF) that may be transmitted in one or more messages according to a communication protocol. Here, a DTF may comprise predefined fields that specify terms of a bid request for the service of transmitting a digital object to a destination node. Such predefined fields may be used for providing information to a bidding or bid requesting party such as, for example, size of the digital object to be transmitted (e.g., in bits, bytes, cells, packets, etc.), destination address(es), quality of service, compression format, security, error rates not to exceed prescribed thresholds, billing account number, etc. However, these are merely examples of predefined fields that may be used in DTF for providing a bid request and claimed subject matter is not limited in these respects. In another embodiment, a DTF may be used for all communications messages associated with the process of requesting an upload of one or more digital objects, bidding requests, acceptance of bids, and initiating and/or controlling all aspects of transmission associated with the digital object being transmitted between the source node 110 and one or more destination nodes.

For an embodiment, a provider may track the progress of an upload operation. If an upload operation is interrupted, a provider may for one embodiment transmit an updated upload request price quote to the customer and the customer may retry the upload operation.

For an example embodiment, an upload request from a customer may be received at an ISP or other intermediary wherein the upload request includes information regarding requested quality of service and digital content size. Other information may also be included in the upload request, although the scope of the claimed subject matter is not limited in this respect. Also for this example, an upload request price quote based on the requested quality of service and digital content size may be transmitted from the ISP or other intermediary to the customer. A price quote acceptance may be received from the customer. The customer may commence uploading the digital content to the ISP or other intermediary. For one embodiment, an updated upload request price quote may be delivered to the customer during the upload of the digital content. For another embodiment, a series of updated upload request price quotes may be transmitted to the customer at regular or non-regular intervals during the upload of the digital content. For another example embodiment, the ISP or other intermediary may begin to transmit the digital content to a destination node before the upload of the digital content from the customer Is complete.

For an embodiment, the digital content may be divided into sub-objects, and separate upload request price quotes and/or updated upload request price quotes may be generated for the various sub-objects. A sub-object may be uploaded from the customer to the ISP or other intermediary upon acceptance of the upload request price quote or updated upload request price quote associated with that particular sub-object. The sub-object may be transmitted from the ISP or other intermediary to the destination node without waiting for the entire digital content to be uploaded by the customer. However, these are merely examples of uploading and/or transmitting digital content, and the scope of the claimed subject matter is not limited in these respects.

What is claimed is:

1. A method, comprising:
receiving an upload request from a customer, the upload request including information regarding requested quality of service and digital content size;
transmitting an upload request price quote based on the requested quality of service and digital content size to the customer; and
receiving a price quote acceptance from the customer.

2. The method of claim 1, further comprising configuring a router to provide requested quality of service.

3. The method of claim 2, further comprising receiving an upload of the digital content from the customer.

4. The method of claim 3, further comprising tracking progress of the upload from the customer.

5. The method of claim 4, further comprising transmitting an updated upload request price quote to the customer in response to a termination of the upload by the customer.

6. The method of claim 4, further comprising transmitting an updated upload request price quote to the customer during the upload of the digital content from the customer.

7. The method of claim 4, further comprising transmitting a series of updated upload request price quotes to the customer at regular intervals during the upload of the digital content from the customer.

8. The method of claim 7, further transmitting at least a portion of the digital content to a destination node in response to receiving the price quote acceptance from the customer.

9. The method of claim 8, wherein the transmission of the at least a portion of the digital content commences during the upload of the digital content from the customer.

10. The method of claim 1, the upload request from the customer further including information regarding upload transmission speed.

11. The method of claim 1, the upload request from the customer further including information regarding requested delivery time.

12. The method of claim 1, the upload request from the customer further including information regarding compression of the digital content.

13. The method of claim 1, the upload request from the customer further including information regarding security of the digital content.

14. The method of claim 1, the upload request from the customer further including billing account information.

15. A method, comprising:
receiving an upload request from a customer, the upload request including information regarding requested price, requested quality of service, and digital content size;
transmitting an upload request acceptance to the customer; and
configuring a router to provide requested quality of service.

16. The method of claim 15, further comprising receiving an upload of the digital content from the customer.

17. The method of claim 16, further comprising tracking progress of the upload from the customer.

18. The method of claim 17, further comprising transmitting an updated price quote to the customer in response to a termination of the upload by the customer.

19. The method of claim 15, the upload request from the customer further including information regarding upload transmission speed.

20. The method of claim 15, the upload request from the customer further including information regarding requested delivery time.

21. The method of claim 15, the upload request from the customer further including information regarding compression of the digital content.

22. The method of claim 15, the upload request from the customer further including information regarding security of the digital content.

23. The method of claim 15, the upload request from the customer further including billing account information.

24. An apparatus, comprising: a computing platform adapted to
receive an upload request from a customer, the upload request including information regarding requested quality of service and digital content size;
transmit an upload request price quote based on the requested quality of service and digital content size to the customer; and
receive a price quote acceptance from the customer.

25. The apparatus of claim 24, the computing platform further adapted to configure a router to provide requested quality of service.

26. The apparatus of claim 25, the computing platform further adapted to receive an upload of the digital content from the customer.

27. The apparatus of claim 26, the computing platform further adapted to track progress of the upload from the customer.

28. The apparatus of claim 27, the computing platform further adapted to transmit an updated upload request price quote to the customer in response to a termination of the upload by the customer.

29. The apparatus of claim 27, the computing platform further adapted to transmit an updated upload request price quote to the customer during the upload of the digital content from the customer.

30. The apparatus of claim 27, the computing platform further adapted to transmit a series of updated upload request price quotes to the customer at regular intervals during the upload of the digital content from the customer.

31. The apparatus of claim 30, the computing platform further adapted to transmit at least a portion of the digital content to a destination node in response to receiving the price quote acceptance from the customer.

32. The apparatus of claim 31, wherein the computing platform is adapted to commence the transmission of the at least a portion of the digital content during the upload of the digital content from the customer.

33. The apparatus of claim 24, the upload request from the customer further including information regarding upload transmission speed.

34. The apparatus of claim 24, the upload request from the customer further including information regarding requested delivery time.

35. The apparatus of claim 24, the upload request from the customer further including information regarding compression of the digital content.

36. The apparatus of claim 24, the upload request from the customer further including information regarding security of the digital content.

37. The apparatus of claim 24, the upload request from the customer further including billing account information.

38. An apparatus, comprising: a computing platform adapted to
receive an upload request from a customer, the upload request including information regarding requested price, requested quality of service, and digital content size;
transmit an upload request acceptance to the customer; and
configure a router to provide requested quality of service.

39. The apparatus of claim 38, the computing platform further adapted to receive an upload of the digital content from the customer.

40. The apparatus of claim 39, the computing platform further adapted to track progress of the upload from the customer.

41. The apparatus of claim 40, the computing platform further adapted to transmit an updated price quote to the customer in response to a termination of the upload by the customer.

42. The apparatus of claim 38, the upload request from the customer further including information regarding upload transmission speed.

43. The apparatus of claim 38, the upload request from the customer further including information regarding requested delivery time.

44. The apparatus of claim 38, the upload request from the customer further including information regarding compression of the digital content.

45. The apparatus of claim 38, the upload request from the customer further including information regarding security of the digital content.

46. The apparatus of claim 38, the upload request from the customer further including billing account information.

47. An article comprising: a storage medium having stored thereon instructions, that, if executed, result in performance of a method comprising:
receiving an upload request from a customer, the upload request including information regarding requested quality of service and digital content size;
transmitting an upload request price quote based on the requested quality of service and digital content size to the customer; and
receiving a price quote acceptance from the customer.

48. The article of claim 47, wherein said instructions, if executed, further result in configuring a router to provide requested quality of service.

49. The article of claim 47, wherein said instructions, if executed, further result in receiving an upload of the digital content from the customer.

50. The article of claim 49, wherein said instructions, if executed, further result in tracking progress of the upload from the customer.

51. The article of claim 50, wherein said instructions, if executed, further result in transmitting an updated upload request price quote to the customer in response to a termination of the upload by the customer.

52. The article of claim 50, wherein said instructions, if executed, further result in transmitting an updated upload request price quote to the customer during the upload of the digital content from the customer.

53. The article of claim 50, wherein said instructions, if executed, further result in transmitting a series of updated upload request price quotes to the customer at regular intervals during the upload of the digital content from the customer.

54. The article of claim 53, wherein said instructions, if executed, further result in transmitting at least a portion of the digital content to a destination node in response to receiving the price quote acceptance from the customer.

55. The article of claim 54, wherein said instructions, if executed, further result in commencing the transmission of the at least a portion of the digital content during the upload of the digital content from the customer.

56. The article of claim 47, wherein the upload request from the customer further includes information regarding upload transmission speed.

57. The article of claim 47, wherein the upload request from the customer further includes information regarding requested delivery time.

58. The article of claim 47, the upload request from the customer further including information regarding compression of the digital content.

59. The article of claim 47, the upload request from the customer further including information regarding security of the digital content.

60. The article of claim 47, the upload request from the customer further including billing account information.

61. An article comprising: a storage medium having stored thereon instructions, that, if executed, result in performance of a method comprising:
receiving an upload request from a customer, the upload request including information regarding requested price, requested quality of service, and digital content size;
transmitting an upload request acceptance to the customer; and
configuring a router to provide requested quality of service.

62. The article of claim 61, wherein said instructions, if executed, further result in receiving an upload of the digital content from the customer.

63. The article of claim 62, wherein said instructions, if executed, further result in tracking progress of the upload from the customer.

64. The article of claim 63, wherein said instructions, if executed, further result in transmitting an updated price quote to the customer in response to a termination of the upload by the customer.

65. The article of claim 61, the upload request from the customer further including information regarding upload transmission speed.

66. The article of claim 61, the upload request from the customer further including information regarding requested delivery time.

67. The article of claim 61, the upload request from the customer further including information regarding compression of the digital content.

68. The article of claim 61, the upload request from the customer further including information regarding security of the digital content.

69. The article of claim 61, the upload request from the customer further including billing account information.
